(19) United States
(12) Patent Application Publication
(10) Pub. No.: US 2021/0055423 A1
(43) Pub. Date: Feb. 25, 2021

(54) GPSavalife emergency evacuation system

(71) Applicants: Allen Lee Frutig, LaGrange, IN (US); Samuel Allen Frutig, Fort Wayne, IN (US)

(72) Inventors: Allen Lee Frutig, LaGrange, IN (US); Samuel Allen Frutig, Fort Wayne, IN (US)

(21) Appl. No.: 16/602,160

(22) Filed: Aug. 19, 2019

(51) Int. Cl. G01S 19/17

(52) U.S. Cl. CPC G01S 19/17

(57) ABSTRACT

This is a method of insuring the successful evacuation of all individuals occupying a structure or area during an emergency event by incorporating a computer program in conjunction with specific individual Global Positioning System (GPS) Receivers. The computer program will display the geographical location of each active Receiver in real time. The computer program is programmed to monitor a specified geographical structure or area. Successful evacuation of all individuals is verified when all designated specific active GPS Receivers are registering geographically outside of the definitive structure or area, as designated on the computer monitor screen.

### BACKGROUND OF INVENTION

### 1. Field of Invention

This invention relates to the methodology of documenting the complete evacuation of a structure or area during an emergency.

### 2. Background

Attempted solutions for documenting the evacuation of all individuals occupying a structure or area have not resolved the problematic matter of insuring that each person has in fact exited the building or locality of the emergency. Heretofore, methodologies are based on either the manual process of Department Head Counting or a mathematical balancing equation comparing the number of individuals entering and then exiting the location. The intent of these solutions is to identify those persons who have successfully evacuated and thereby speculate if any individual remains in the evacuation zone.

Solution deficiencies arise in this numerical modus operandi due to the managerial lag time in daily documentation of department headcounts, inaccurate metering of the number of persons entering the location, erroneous monitoring of individuals casually departing and the lack of individuals following precise instructions or procedures during an emergency. Anyone of these solution deficiencies, or a combination of two or more, renders the methodology minimally effective in documenting exactly who has completed the evacuation of the structure or area.

Therefore, heretofore solutions do not provide maximum human health and safety preservation in three regards. First, persons remaining in the emergency location are not definitively or expeditiously confirmed and documented. Second, the location of the suspected person(s) remaining in the emergency location cannot be definitively ascertained. Third, the lack of definitive documentation of specific individuals and their location within a structure or area during an emergency, places First Responders at risk during Search and Rescue Operations.

### BRIEF SUMMARY OF THE INVENTION

The GPSavealife intellectual property invention is a computer program interfaced with the Global Satellite Positioning system and specified individual GPS Receiver Devices, for the objective of establishing absolute verification that every individual has exited a structure or area during an emergency event.

### DETAILED DESCRIPTION OF THE INVENTION

The embodiment of the invention comprises two components electronically communicating in conjunction with the U.S. Global Positioning System (GPS), for the purpose of positively ascertaining that individuals in possession of designated GPS Receivers within a given geographical boundary have gathered at appropriate designated locations in response to a declared emergency event. The first component is a computer designed program that simultaneously performs multi operational functions. These functions are as follows:
A. A program that definitively identifies exact geographical boundaries and
B. A program to display said geographical boundaries on a monitor as structures and adjacent property and
C. A program that receives said GPS electronic signals from the said Global Positioning
System in current exact time and
D. A program that displays said GPS electronic signal's location within the said displayed geographical boundaries and
E. A program that monitors movement of said GPS electronic signals in current exact time and
F. A program that electronically sends communications to designated Receivers designed to utilize the said U.S. Global Positioning System.

The second component of this invention is a designed GPS Receiver that performs multi operational functions. These functions are as follows:
A. A program to receive said GPS data in order to ascertain exact positioning of the Receiver device and
B. A program to send GPS Receiver positioning data in current exact time to a receiving computer program device and
C. A program to receive electronic communications from a designated computer home base program and
D. A program to emit an audio signal in response from the said computer home base program and
E. A program to initiate a mechanical physical action in response to the electronic communications from the said computer home base program.
   whereby, the invention performs as follows:

The said GPS Receiver Device is acquired by each individual entering the designated geographical boundary. The said computer program receives communication transmissions from each distributed said GPS Receiver Device in current exact time, which displays the said GPS Receiver's position within the designated geographical boundary in current exact time.

In the event of an emergency situation, the said operator of the said computer program transmits the appropriate emergency alert to the said GPS Receiver Devices in current exact time. Individuals in possession of the said GPS Receiver Device respond to the said electronic communications by proceeding to assigned locations as dictated by the nature of the emergency.

The said operator of the said computer program monitors the movement of said GPS Receiver Devices in current exact time. The said computer program is able to document that all said GPS Receiver Devices have reached the said designated assign location.

The embodiments of the intellectual property invention in which an exclusive property or privilege is claimed are defined as follows:

1. A method of inserting Global Positioning System Receiver Signals (GPS) into a computer monitoring program providing a memory data system to store multiple GPS receiver signals at an adjacent series of addresses in said memory.

2. A method of defining a geographical location or physical boundaries or geographical borders at adjacent series of addresses in said memory.

3. A method of defining said geographical location or physical boundaries or geographical borders in two dimensional or three dimensional configuration.

4. A method of storing a series of characters in said adjacent series of addresses to display said geographical location or physical boundaries or geographical borders in said memory.

5. A method of displaying said GPS receiver signals in said memory on a monitor device.

6. A method of displaying said series of characters in said adjacent series of addresses to display said geographical location or physical boundaries or geographical borders in said memory on a monitor device.

7. A method of displaying said GPS receiving signals on said monitor in said memory in current exact time of the said GPS receiving signals receipt into said memory.

8. A method of specifying exact GPS Receiving Signals to be received into said memory.

9. A method of displaying said GPS Receiving Signals movement or travel progression in current exact time of the said GPS receiving signals receipt into said memory.

10. A Global Positioning System Receiver device programmed with a data system to be compatible with and exclusive to said memory data system.

11. Whereby said memory on said monitory device will display said GPS receiving signal in relationship to said geographical location or physical boundaries or geographical borders in current exact time.

12. Whereby said memory data system operator can ascertain the location of said compatible GPS Receiving Devices in current exact time within said geographical location or physical boundaries or geographical borders.

13. Whereby said operator can ascertain the degree of movement of said GPS Receiver Devices in current exact time.

14. Whereby said memory data system has the capability to send communications to said GPS Receiver Devices.

15. Whereby said GPS Receiver Devices have the methodology of a receiver memory data system for receiving said communications.

16. Whereby the said GPS Receiver Devices are designed with audio response components that activate upon receipt of said communications.

17. Whereby the said GPS Receiver Devices are designed with mechanical physical response components that activate upon receipt of said communications.

18. Whereby said operator can confirm from the said computer monitoring program memory data system that said receivers have responded appropriately to said communications and moved to the appropriate designated location.
